(19) United States
(12) Patent Application Publication
(10) Pub. No.: US 2017/0365854 A1
(43) Pub. Date: Dec. 21, 2017

(54) INTERPHASE LAYER FOR IMPROVED LITHIUM METAL CYCLING

(71) Applicant: Applied Materials, Inc., Santa Clara, CA (US)

(72) Inventors: Girish GOPALAKRISHNANNAIR, San Jose, CA (US); Subramanya P. HERLE, Mountain View, CA (US)

(21) Appl. No.: 15/590,250

(22) Filed: May 9, 2017

Related U.S. Application Data
(60) Provisional application No. 62/352,702, filed on Jun. 21, 2016.

(51) Int. Cl. H01M 4/583; H01M 4/1395; H01M 4/04; H01M 4/134; H01M 4/64; H01M 4/02

(52) U.S. Cl. CPC H01M 4/5835; H01M 4/134; H01M 4/64; H01M 4/1395; H01M 4/0414; H01M 4/0428; H01M 4/0426; H01M 2004/023

(57) ABSTRACT

Implementations described herein generally relate to metal electrodes, more specifically, lithium-containing anodes, high performance electrochemical devices, such as secondary batteries, including the aforementioned lithium-containing electrodes, and methods for fabricating the same. In one implementation, a rechargeable battery is provided. The rechargeable battery comprises a cathode film including a lithium transition metal oxide, a separator film coupled to the cathode film and capable of conducting ions, a solid electrolyte interphase film coupled to the separator, wherein the solid electrolyte interphase film is a lithium fluoride film or a lithium carbonate film, a lithium metal film coupled to the solid electrolyte interphase film and an anode current collector coupled to the lithium metal film.

### CROSS-REFERENCE TO RELATED APPLICATIONS

This application claims benefit of U.S. provisional patent application Ser. No. 62/352,702, filed Jun. 21, 2016. The aforementioned related patent application is herein incorporated by reference in its entirety.

### BACKGROUND

### Field

Implementations described herein generally relate to metal electrodes, more specifically lithium-containing anodes, high performance electrochemical devices, such as secondary batteries, including the aforementioned lithium-containing electrodes, and methods for fabricating the same.

### Description of the Related Art

Rechargeable electrochemical storage systems are becoming increasingly key for many fields of everyday life. High-capacity energy storage devices, such as lithium-ion (Li-ion) batteries and capacitors, are used in a growing number of applications, including portable electronics, medical, transportation, grid-connected large energy storage, renewable energy storage, and uninterruptible power supply (UPS). In each of these applications, the charge/discharge time and capacity of energy storage devices are key parameters. In addition, the size, weight, and/or cost of such energy storage devices are also key parameters. Further, low internal resistance is necessary for high performance. The lower the resistance, the less restriction the energy storage device encounters in delivering electrical energy. For example, in the case of a battery, internal resistance affects performance by reducing the total amount of useful energy stored by the battery as well as the ability of the battery to deliver high current.

Li-ion batteries are thought to have the best chance at achieving the sought after capacity and cycling. However, Li-ion batteries as currently constituted often lack the energy capacity and number of charge/discharge cycles for these growing applications.

Accordingly, there is a need in the art for faster charging, higher capacity energy storage devices that have improved cycling, and can be more cost effectively manufactured. There is also a need for components for an energy storage device that reduce the internal resistance of the storage device.

### SUMMARY

Implementations described herein generally relate to metal electrodes, more specifically, lithium-containing anodes, high performance electrochemical devices, such as secondary batteries, including the aforementioned lithium-containing electrodes, and methods for fabricating the same. In one implementation, an energy storage device is provided. The energy storage device comprises a cathode film including a lithium transition metal oxide, a separator film coupled to the cathode film and capable of conducting ions, a solid electrolyte interphase film coupled to the separator, a lithium metal film coupled to the solid electrolyte interphase film, and an anode current collector coupled to the lithium metal film. The solid electrolyte interphase film is a lithium fluoride film or a lithium carbonate film.

In another implementation, a method of forming an energy storage device is provided. The method comprises depositing a solid electrolyte interphase layer on a lithium film by powder deposition process, a physical vapor deposition (PVD) process, a slot-die process, a thin-film transfer process, a three-dimensional lithium printing process, or ultrathin lithium extrusion process, wherein the solid electrolyte interphase layer is a lithium fluoride film or a lithium carbonate film.

In yet another implementation, an integrated processing tool for forming lithium-coated electrodes is provided. The integrated processing tool comprises a reel-to-reel system for transporting a continuous sheet of material through following processing chambers. The integrated processing tool further comprises a chamber for depositing a thin film of lithium metal on the continuous sheet of material. The integrated processing tool further comprises a chamber for depositing a solid electrolyte interphase film on a surface of the thin film of lithium metal, wherein the solid electrolyte interphase layer is a lithium fluoride film or a lithium carbonate film.

### BRIEF DESCRIPTION OF THE DRAWINGS

So that the manner in which the above-recited features of the present disclosure can be understood in detail, a more particular description of the implementations, briefly summarized above, may be had by reference to implementations, some of which are illustrated in the appended drawings. It is to be noted, however, that the appended drawings illustrate only typical implementations of this disclosure and are therefore not to be considered limiting of its scope, for the disclosure may admit to other equally effective implementations.

FIG. 1A illustrates a schematic cross-sectional view of one implementation of an energy storage device incorporating an electrode structure having a solid electrolyte interphase (SEI) layer formed according to implementations described herein;

FIG. 1B illustrates a schematic cross-sectional view of an anode electrode structure having an SEI film formed according to implementations described herein;

FIG. 1C illustrates a schematic cross-sectional view of another anode electrode structure having an SEI film formed according to implementations described herein;

FIG. 2 illustrates a schematic view of a web tool for forming an anode electrode structure having an SEI film according to implementations described herein;

FIG. 3 illustrates a process flow chart summarizing one implementation of a method for forming an anode electrode structure having an SEI film according to implementations described herein;

FIG. 4 illustrates a plot of cell voltage versus time for a symmetric lithium cell at a current density of 3.0 mA cm⁻²;

FIGS. 5A-5B illustrate scanning electron microscopy (SEM) images of an untreated lithium metal electrode formed according to implementations described herein;

FIGS. 5C-5D illustrate SEM images of a treated lithium metal electrode formed thereon according to implementations described herein; and

FIG. 6A illustrates a plot of discharge capacity versus C-rate performance for a lithium metal electrode without an SEI film of the present disclosure verses a lithium metal electrode having an SEI film formed according to implementations described herein; and

FIG. 6B illustrates a plot of discharge capacity versus cycle number for a lithium metal electrode without an SEI film of the present disclosure verses a lithium metal electrode having an SEI film formed according to implementations described herein.

To facilitate understanding, identical reference numerals have been used, where possible, to designate identical elements that are common to the figures. It is contemplated that elements and features of one implementation may be beneficially incorporated in other implementations without further recitation.

### DETAILED DESCRIPTION

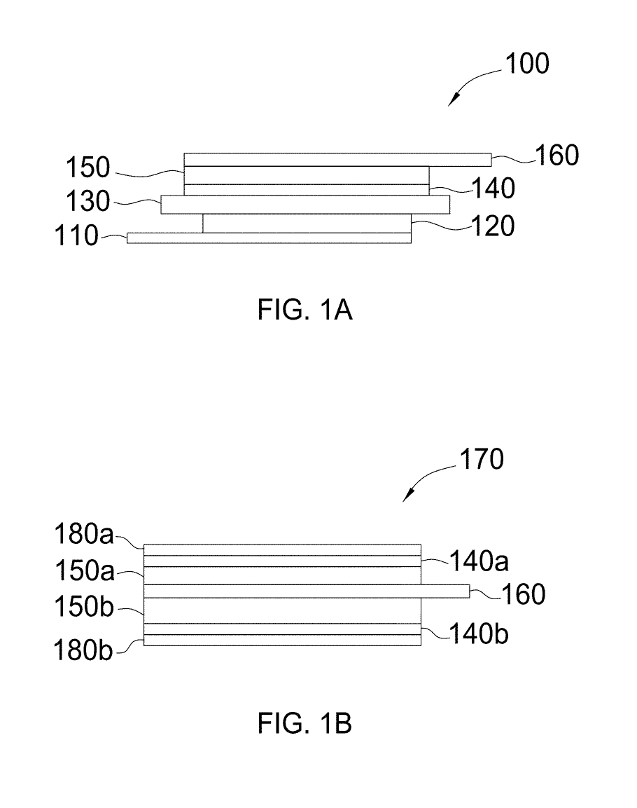

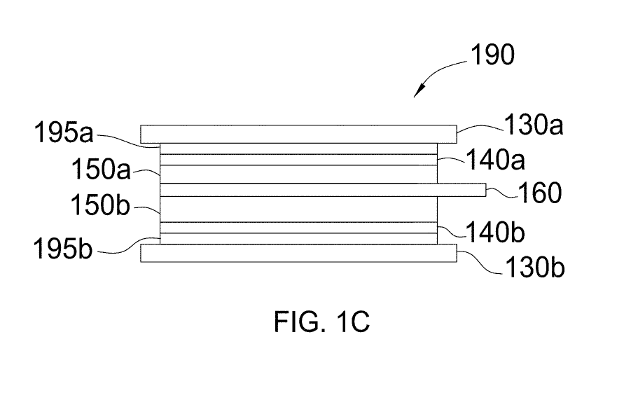

The following disclosure describes lithium-containing electrodes, high performance electrochemical devices, such as secondary batteries, including the aforementioned lithium-containing electrodes, and methods for fabricating the same. Certain details are set forth in the following description and in FIGS. 1-6B to provide a thorough understanding of various implementations of the disclosure. Other details describing well-known structures and systems often associated with electrochemical cells and secondary batteries are not set forth in the following disclosure to avoid unnecessarily obscuring the description of the various implementations.

Many of the details, dimensions, angles and other features shown in the Figures are merely illustrative of particular implementations. Accordingly, other implementations can have other details, components, dimensions, angles and features without departing from the spirit or scope of the present disclosure. In addition, further implementations of the disclosure can be practiced without several of the details described below.

Implementations described herein will be described below in reference to a reel-to-reel coating system, such as TopMet®, SMARTWEB®, TOPBEAM®, all of which are available from Applied Materials, Inc. of Santa Clara, Calif. Other tools capable of performing high rate evaporation processes may also be adapted to benefit from the implementations described herein. In addition, any system enabling high rate evaporation processes described herein can be used to advantage. The apparatus description described herein is illustrative and should not be construed or interpreted as limiting the scope of the implementations described herein. It should also be understood that although described as a reel-to-reel process, the implementations described herein may also be performed on discrete substrates.

The term “crucible” as used herein shall be understood as a unit capable of evaporating material that is fed to the crucible when the crucible is heated. In other words, a crucible is defined as a unit adapted for transforming solid material into vapor. Within the present disclosure, the term “crucible” and “evaporation unit” are used synonymously. The crucible may be connected to the deposition showerhead or linear evaporator for better film uniformity.

Development of rechargeable lithium metal batteries is considered the most promising new technology, which can enable a high-energy-density system for energy storage. However, current lithium metal batteries suffer from dendrite growth, which hinders the practical applications of lithium metal batteries in portable electronics and electric vehicles. Over the course of several charge/discharge cycles, microscopic fibers of lithium, called dendrites form on the lithium metal surface and spread until contacting the other electrode. Passing electrical current through these dendrites can short circuit the battery. One of the most challenging aspects to enable a lithium metal battery is the development of a stable and efficient solid electrolyte interphase (SEI). A stable and efficient SEI provides an effective strategy for inhibiting dendrite growth and thus achieving improved cycling.

Current SEI films are typically formed in-situ during the cell formation cycling process, which is generally performed immediately after the cell fabrication step. During the cell formation cycling process, when an appropriate potential is established on the anode and particular organic solvents are used as the electrolyte, the organic solvent is decomposed and forms the SEI film at first charge. With typical liquid electrolytes and under lower current density, a mossy Lithium deposit was reported and the lithium growth was attributed to “bottom growth.” At higher current densities, concentration gradient in the electrolyte causing ‘tip growth’ and this tip growth is causing shorting of the cell. Depending upon the organic solvents used, the SEI film that forms on the anode is typically a mixture of lithium oxide, lithium fluoride, and semicarbonates. Initially, the SEI film is electrically insulating yet sufficiently conductive to lithium ions. The SEI prevents decomposition of the electrolyte after the second charge. The SEI can be thought of as a three-layer system with two key interfaces. In conventional electrochemical studies, it is often referred to as an electrical double layer. In its simplest form, an anode coated by an SEI will undergo three steps when charged: electron transfer between the anode (M) and the SEI (M⁰−ne→Mⁿ⁺_{M/SEI}), cation migration from the anode-SEI interface to the SEI-electrolyte (E) interface (Mⁿ⁺_{M/SEI}→Mⁿ⁺_{SEI/E}), and cation transfer in the SEI to electrolyte at the SEI/electrolyte interface (E(solv)+Mⁿ⁺_{SEI/E}→Mⁿ⁺E(solv)).

The power density and recharge speed of the battery is dependent on how quickly the anode can release and gain charge. This, in turn, is dependent on how quickly the anode can exchange lithium ions with the electrolyte through the SEI. Lithium ion exchange at the SEI is a multi-step process and as with most multi-step processes, the speed of the entire process is dependent upon the slowest step. Studies have shown that anion migration is the bottleneck for most systems. It was also found that the diffusive characteristics of the solvents dictate the speed of migration between the anode-SEI interface and the SEI-electrolyte (E) interface. Thus, the best solvents have little mass in order to maximize the speed of diffusion.

Although the specific properties and reactions that take place at the SEI are not well understood, it is known that these properties and reactions can have profound effects on the cycling and capacity of the anode electrode structure. It is believed that when cycled, the SEI can thicken, slowing diffusion from the Electrode/SEI interface to the SEI/Electrolyte. For example, at elevated temperatures, alkyl carbonates in the electrolyte decompose into insoluble Li₂CO₃ that can increase the thickness of the SEI film, clog pores of the SEI film, and limit lithium ion access to the anode. SEI growth can also occur by gas evolution at the cathode and particles migrating towards the anode. This, in turn, increases impedance and decreases capacity. Further, the randomness of metallic lithium embedded in the anode during intercalation results in dendrite formation. Over time, the dendrites pierce the separator, causing a short circuit leading to heat, fire and/or explosion.

Implementations of the present disclosure relate to constructing a stable and an efficient SEI film ex-situ. The SEI film is formed in the energy storage device during fabrication of the energy storage device. This new and efficient SEI film is believed to inhibit lithium dendrite growth and thus achieve superior lithium metal cycling performance relative to current lithium based anodes, which rely on an in-situ SEI film.

FIG. 1A illustrates a cross-sectional view of one implementation of an energy storage device 100 incorporating an anode electrode structure having an SEI film 140 formed according to implementations described herein. In some implementations, the energy storage device 100 is a rechargeable battery cell. In some implementations, the energy storage device 100 is combined with other cells to form a rechargeable battery. The energy storage device 100 has a cathode current collector 110, a cathode film 120, a separator film 130, the SEI film 140, an anode film 150 and an anode current collector 160. Note in FIG. 1 that the current collectors and separator are shown to extend beyond the stack, although it is not necessary for the current collectors to extend beyond the stack, the portions extending beyond the stack may be used as tabs. The ex-situ formed SEI layer can have more than one layer for e.g., LiF in combination with ion conducting solid polymers, gel polymer (organic inorganic composites) and carbon.

The current collectors 110, 160, on the cathode film 120 and the anode film 150, respectively, can be identical or different electronic conductors. Examples of metals that the current collectors 110, 160 may be comprised of include aluminum (Al), copper (Cu), zinc (Zn), nickel (Ni), cobalt (Co), tin (Sn), silicon (Si), manganese (Mn), magnesium (Mg), alloys thereof, and combinations thereof. In one implementation, at least one of the current collectors 110, 160 is perforated. Furthermore, current collectors may be of any form factor (e.g., metallic foil, sheet, or plate), shape and micro/macro structure. Generally, in prismatic cells, tabs are formed of the same material as the current collector and may be formed during fabrication of the stack, or added later. All components except current collectors 110 and 160 contain lithium ion electrolytes. In one implementation, the cathode current collector 110 is aluminum. In one implementation, the cathode current collector 110 has a thickness from about 0.5 μm to about 20 μm (e.g., from about 1 μm to about 10 μm; from about 5 μm to about 10 μm). In one implementation, the anode current collector 160 is copper. In one implementation, the anode current collector 160 has a thickness from about 0.5 μm to about 20 μm (e.g., from about 1 μm to about 10 μm; from about 5 μm to about 10 μm).

The anode film 150 or anode may be any material compatible with the cathode film 120 or cathode. The anode film 150 may have an energy capacity greater than or equal to 372 mAh/g, preferably 700 mAh/g, and most preferably 1000 mAh/g. The anode film 150 may be constructed from a graphite, silicon-containing graphite, lithium metal, lithium metal foil or a lithium alloy foil (e.g. lithium aluminum alloys), or a mixture of a lithium metal and/or lithium alloy and materials such as carbon (e.g. coke, graphite), nickel, copper, tin, indium, silicon, oxides thereof, or combinations thereof. The anode film 150 typically comprises intercalation compounds containing lithium or insertion compounds containing lithium. In some implementations, wherein the anode film 150 comprises lithium metal, the lithium metal may be deposited using the methods described herein. The anode film may be formed by extrusion, physical or chemical thin-film techniques, such as sputtering, electron beam evaporation, chemical vapor deposition (CVD), three-dimensional printing, lithium powder deposition etc. In one implementation, the anode film 150 has a thickness from about 0.5 μm to about 20 μm (e.g., from about 1 μm to about 10 μm; from about 5 μm to about 10 μm). In one implementation, the anode film 150 is a lithium metal or alloying film.

The SEI film 140 is formed ex-situ on the anode film 150. The SEI film 140 is electrically insulating yet sufficiently conductive to lithium-ions. In one implementation, the SEI film 140 is a nonporous film. In another implementation, the SEI film 140 is a porous film. In one implementation, the SEI film 140 has a plurality of nanopores that are sized to have an average pore size or diameter less than about 10 nanometers (e.g., from about 1 nanometer to about 10 nanometers; from about 3 nanometers to about 5 nanometers). In another implementation, the SEI film 140 has a plurality of nanopores that are sized to have an average pore size or diameter less than about 5 nanometers. In one implementation, the SEI film 140 has a plurality of nanopores having a diameter ranging from about 1 nanometer to about 20 nanometers (e.g., from about 2 nanometers to about 15 nanometers; or from about 5 nanometers to about 10 nanometers).

The SEI film 140 may be a coating or a discrete layer, either having a thickness in the range of 1 nanometer to 200 nanometers (e.g., in the range of 5 nanometers to 200 nanometers; in the range of 10 nanometers to 50 nanometers). Not to be bound by theory, but it is believed that SEI films greater than 200 nanometers may increase resistance within the rechargeable battery.

Examples of materials that may be used to form the SEI film 140 include, but are not limited to, lithium fluoride (LiF), lithium carbonate (Li₂CO₃), and combinations thereof. In one implementation, the SEI film 140 is a lithium fluoride film. Not to be bound by theory but it is believed that the SEI film 140 can take-up Li-conducting electrolyte to form gel during device fabrication which is beneficial for forming good solid electrolyte interface (SEI) and also helps lower resistance. The SEI film 140 can be directly deposited on the lithium metal film by Physical Vapor Deposition (PVD), such as evaporation or sputtering, a slot-die process, a thin-film transfer process, or a three-dimensional lithium printing process. PVD is a preferred method for deposition of the SEI film 140. The SEI film 140 can also be deposited using Metacoat equipment.

The cathode film 120 or cathode may be any material compatible with the anode and may include an intercalation compound, an insertion compound, or an electrochemically active polymer. Suitable intercalation materials include, for example, lithium-containing metal oxides, MoS₂, FeS₂, MnO₂, TiS₂, NbSe₃, LiCoO₂, LiNiO₂, LiMnO₂, LiMn₂O₄, V₆O₁₃ and V₂O₅. Suitable polymers include, for example, polyacetylene, polypyrrole, polyaniline, and polythiopene. The cathode film 120 or cathode may be made from a layered oxide, such as lithium cobalt oxide, an olivine, such as lithium iron phosphate, or a spinel, such as lithium manganese oxide. Exemplary lithium-containing oxides may be layered, such as lithium cobalt oxide (LiCoO₂), or mixed metal oxides, such as LiNiₓCo₁₋₂ₓMnO₂, LiNiMnCoO₂ (“NMC”), LiNi_{0.5}Mn_{1.5}O₄, Li(Ni_{0.6}Co_{0.15}Al_{0.05})O₂, LiMn₂O₄, and doped lithium rich layered-layered materials, wherein x is zero or a non-zero number. Exemplary phosphates may be iron olivine (LiFePO₄) and it is variants (such as LiFe(₁₋ₓ)MgₓPO₄, wherein x is between 0 and 1), LiMoPO₄, LiCoPO₄, LiNiPO₄, Li₃V₂(PO₄)₃, LiVOPO₄, LiMP₂O₇, or LiFe₁.₅P₂O₇, wherein x is zero or a non-zero number. Exemplary fluorophosphates may be LiVPO₄F, LiAIPO₄F, Li₅V(PO₄)₂F₂, Li₅Cr(PO₄)₂F₂, Li₂CoPO₄F, or Li₂NiPO₄F. Exemplary silicates may be Li₂FeSiO₄, Li₂MnSiO₄, or Li₂VOSiO₄. An exemplary non-lithium compound is Na₅V₂(PO₄)₂F₃. The cathode film 120 may be formed by physical or chemical thin-film techniques, such as sputtering, electron beam evaporation, chemical vapor deposition (CVD), etc. In one implementation, the cathode film 120 has a thickness from about 10 μm to about 100 μm (e.g., from about 30 μm to about 80 μm; or from about 40 μm to about 60 μm). In one implementation, the cathode film 120 is a LiCoO₂ film. In another implementation, the cathode film 120 is an NMC film.

The separator film 130 comprises a porous (e.g., microporous) polymeric substrate capable of conducting ions (e.g., a separator film) with pores. In some implementations, the porous polymeric substrate itself does not need to be ion conducting, however, once filled with electrolyte (liquid, gel, solid, combination etc.), the combination of porous substrate and electrolyte is ion conducting. In one implementation, the porous polymeric substrate is a multi-layer polymeric substrate. In one implementation, the pores are micropores. In some implementations, the porous polymeric substrate consists of any commercially available polymeric microporous membranes (e.g., single-ply or multi-ply), for example, those products produced by Polypore (Celgard Inc., of Charlotte, N.C.), Toray Tonen (Battery separator film (BSF)), SK Energy (Li-ion battery separator (LiBS), Evonik industries (SEPARION® ceramic separator membrane), Asahi Kasei (Hipore™ polyolefin flat film membrane), DuPont (Energain®), etc. In some implementations, the porous polymeric substrate has a porosity in the range of 20 to 80% (e.g., in the range of 28 to 60%). In some implementations, the porous polymeric substrate has an average pore size in the range of 0.02 to 5 microns (e.g., 0.08 to 2 microns). In some implementations, the porous polymeric substrate has a Gurley Number in the range of 15 to 150 seconds (Gurley Number refers to the time it takes for 10 cc of air at 12.2 inches of water to pass through one square inch of membrane). In some implementations, the porous polymeric substrate is polyolefinic. Exemplary polyolefins include polypropylene, polyethylene, or combinations thereof.

In some implementations of a Li-ion cell according to the present disclosure, lithium is contained in the lithium metal film of the anode electrode, lithium fluoride is deposited on the lithium metal film, and lithium manganese oxide (LiMnO₄) or lithium cobalt oxide (LiCoO₂) at the cathode electrode, for example, although in some implementations the anode electrode may also include lithium absorbing materials such as silicon, tin, etc. The cell, even though shown as a planar structure, may also be formed into a cylinder by rolling the stack of layers; furthermore, other cell configurations (e.g., prismatic cells, button cells) may be formed.

Electrolytes infused in cell components 120, 130, 140 and 150 can be comprised of a liquid/gel or a solid polymer and may be different in each. In some implementations, the electrolyte primarily includes a salt and a medium (e.g., in a liquid electrolyte, the medium may be referred to as a solvent; in a gel electrolyte, the medium may be a polymer matrix). The salt may be a lithium salt. The lithium salt may include, for example, LiPF₆, LiAsF₆, LiCF₃SO₃, LiN(CF₃SO₃)₃, LiBF₆, and LiClO₄, lithium bistrifluoromethanesulfonimidate (e.g., LiTFSI), BETTE electrolyte (commercially available from 3M Corp. of Minneapolis, Minn.) and combinations thereof. Solvents may include, for example, ethylene carbonate (EC), propylene carbonate (PC), EC/PC, 2-MeTHF(2-methyltetrahydrofuran)/EC/PC, EC/DMC (dimethyl carbonate), EC/DME (dimethyl ethane), EC/DEC (diethyl carbonate), EC/EMC (ethyl methyl carbonate), EC/EMC/DMC/DEC, EC/EMC/DMC/DEC/PE, PC/DME, and DME/PC. Polymer matrices may include, for example, PVDF (polyvinylidene fluoride), PVDF:THF (PVDF:tetrahydrofuran), PVDF:CTFE (PVDF:chlorotrifluoroethylene) PAN (polyacrylonitrile), and PEO (polyethylene oxide).

FIG. 1B illustrates a cross-sectional view of an anode electrode structure 170 having an SEI film formed according to implementations described herein. The anode electrode structure 170 may be combined with a cathode electrode structure to form a lithium-ion energy storage device. The anode electrode structure 170 has an anode film (e.g., a lithium metal film) 150a, 150b with SEI films 140a, 140b formed thereon according to implementations of the present disclosure. The anode film 150a, 150b may be a thin lithium metal film (e.g., 20 microns or less, from about 1 micron to about 20 microns, from about 2 microns to about 10 microns). In one implementation, the SEI film 140a, 140b is a lithium fluoride film.

In some implementations, a protective film 180a, 180b is formed on the SEI film 140a, 140b. The protective film 180a, 180b may be an interleaf film or ion-conducting polymer film as described herein. In some implementations where protective film 180a, 180b is an interleaf film, the interleaf film is typically removed prior to combining the anode electrode structure 170 with a cathode structure to form a lithium-ion storage device. In some implementations where protective film 180a, 180b is an ion-conducting polymer film, the ion-conducting polymer film may be incorporated into the final battery structure. In some implementations, the protective film 180 is replaced by, for example, the separator film 130.

The anode electrode structure 170 has an anode current collector 160, anode films 150a, 150b formed on the anode current collector 160, SEI films 140a, 140b formed on the anode film 150a, 150b, and optionally protective films 180a, 180b formed on the SEI films 140a, 140b. Although the anode electrode structure 170 is depicted as a dual-sided electrode structure, it should be understood that the implementations described herein also apply to single-sided electrode structures.

FIG. 1C illustrates a schematic cross-sectional view of another anode electrode structure 190 having an SEI film formed according to implementations described herein. The anode electrode structure 190 is similar to the anode electrode structure 170 depicted in FIG. 1B. The anode electrode structure 190 contains a bonding film 195a, 195b (collectively 195) formed on the surface of the SEI film 140 to further enhance the electrical performance of the end device (e.g., battery or capacitor). The bonding film 195 provides, among other things, enhanced bonding of adjacent layers, improved electronic conductivity, decreased resistance, and/or increased ionic conduction. The anode electrode structure 190 further includes separator film 130a, 130b (collectively 130) formed on the bonding film 195a, 195b. In some implementations, the separator film 130 is replaced by, for example, protective film 180 as shown in FIG. 1B.

In one implementation, the bonding film 195 comprises a gel polymer (e.g., organic-inorganic composites), a solid polymer, carbon-containing materials (e.g., graphite), or combinations thereof. The polymer can be chosen from polymers currently used in the Li-ion battery industry. Examples of polymers that may be used to form the bonding film 195 include, but are not limited to, polyvinylidene difluoride (PVDF), polyethylene oxide (PEO), poly-acrylonitrile (PAN), carboxymethyl cellulose (CMC), styrene butadiene rubber (SBR), and combinations thereof. Not to be bound by theory but it is believed that the bonding film 195 can up-take Li-conducting electrolyte to form gel during device fabrication which is beneficial for forming good ion conducting solid electrolyte interface (SEI) and also helps lower resistance. The bonding film 195 can be formed by dip-coating, slot-die coating, gravure coating, chemical vapor deposition (CVD) processes, physical vapor deposition (PVD) processes, and/or printing. The polymer can also be deposited using Applied Materials Metacoat equipment. The bonding film 195 may have a thickness from about 0.01 micrometers to about 1 micrometers (e.g., from about 0.01 micrometers to about 0.5 micrometers; from about 0.1 micrometers to about 2 micrometers; or from about 0.5 micrometers to about 5 micrometers).

Although the anode electrode structure 190 is depicted as a dual-sided electrode structure, it should be understood that the implementations described herein also apply to single-sided electrode structures.

An anode electrode structure may be fabricated using tools of the present disclosure as described herein. According to some implementations, a web tool for forming SEI coated anode electrode structures comprises a reel-to-reel system for transporting a substrate or current collector through the following chambers: a chamber for depositing anode material on the current collector, a chamber for depositing a thin SEI film on the anode electrode structure, and optionally a chamber for depositing a protective film on the SEI film. The chamber for depositing the thin film of lithium may include an evaporation system, such as an electron-beam evaporator, a thermal evaporator system, or a sputtering system, or a thin film transfer system (including large area pattern printing systems such as gravure printing systems).

In some implementations, the tool may further comprise a chamber for surface modification, such as a plasma pretreatment chamber, of the continuous sheet of material prior to deposition of the anode film and the SEI film. Further, in some implementations the tool may further comprise a chamber for depositing a binder soluble in a liquid electrolyte or a Li-ion-conducting dielectric material.

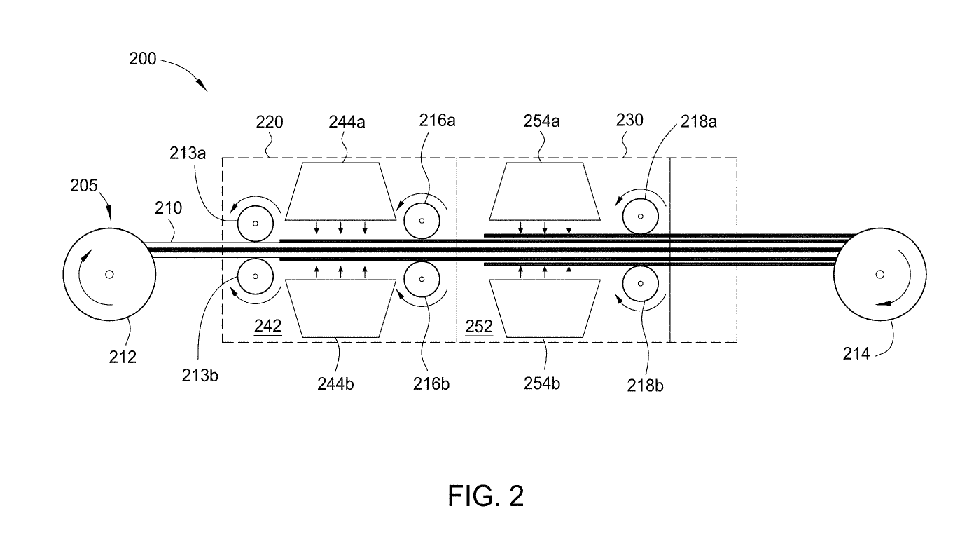

FIG. 2 illustrates a schematic view of an integrated processing tool 200 according to implementations described herein. The integrated processing tool 200 may be used to form an anode electrode structure having an SEI film formed according to implementations described herein. In certain implementations, the integrated processing tool 200 comprises a plurality of processing modules or processing chambers (e.g., a first processing chamber 220 and a second processing chamber 230) arranged in a line, each configured to perform one processing operation to a continuous sheet of material 210. In one implementation, the first processing chamber 220 and the second processing chamber 230 are stand-alone modular processing chambers wherein each modular processing chamber is structurally separated from the other modular processing chambers. Therefore, each of the stand-alone modular processing chambers, can be arranged, rearranged, replaced, or maintained independently without affecting each other. In certain implementations, the processing chambers 220 and 230 are configured to process both sides of the continuous sheet of material 210. Although the integrated processing tool 200 is configured to process a horizontally oriented continuous sheet of material 210, the integrated processing tool 200 may be configured to process substrates positioned in different orientations, for example, a vertically oriented continuous sheet of material 210. In certain implementations, the continuous sheet of material 210 is a flexible conductive substrate.

In certain implementations, the integrated processing tool 200 comprises a transfer mechanism 205. The transfer mechanism 205 may comprise any transfer mechanism capable of moving the continuous sheet of material 210 through the processing region of the processing chambers 220 and 230. The transfer mechanism 205 may comprise common transport architecture. The common transport architecture may comprise a reel-to-reel system with a common take-up-reel 214 and a feed reel 212 for the system. The take-up reel 214 and the feed reel 212 may be individually heated. The take-up reel 214 and the feed reel 212 may be individually heated using an internal heat source positioned within each reel or an external heat source. The common transport architecture may further comprise one or more intermediate transfer reels (213a & 213b, 216a & 216b, 218a & 218b) positioned between the take-up reel 214 and the feed reel 212.

Although the integrated processing tool 200 is depicted as having discrete processing regions, in some implementations, the integrated processing tool 200 has a common processing region. In some implementation, it may be advantageous to have separate or discrete processing regions, modules, or chambers for each process step. For implementations having discrete processing regions, modules, or chambers, the common transport architecture may be a reel-to-reel system where each chamber or processing region has an individual take-up-reel and feed reel and one or more optional intermediate transfer reels positioned between the take-up reel and the feed reel. The common transport architecture may comprise a track system. The track system extends through the processing regions or discrete processing regions. The track system is configured to transport either a web substrate or discrete substrates.

The integrated processing tool 200 may comprise the feed reel 212 and the take-up reel 214 for moving the continuous sheet of material 210 through the different processing chambers including a first processing chamber 220 for deposition of a lithium metal film and a second processing chamber 230 for forming an SEI film coating over the lithium metal film. In some implementations, the finished anode electrode will not be collected on take-up reel 214 as shown in the figures, but may go directly for integration with the separator film and positive electrodes, etc., to form energy storage devices.

The first processing chamber 220 is configured for depositing a thin film of lithium metal on the continuous sheet of material 210. Any suitable lithium deposition process for depositing thin films of lithium metal may be used to deposit the thin film of lithium metal. Deposition of the thin film of lithium metal may be by an ultra-thin extrusion process, PVD processes, such as evaporation or sputtering, a slot-die process, a transfer process, a three-dimensional lithium printing process, or a lithium metal powder deposition. The chamber for depositing the thin film of lithium metal may include a PVD system, such as an electron-beam evaporator, a thermal evaporation system, or a sputtering system, a thin film transfer system (including large area pattern printing systems such as gravure printing systems) or a slot-die deposition system. In one implementation, the chamber for depositing the thin film of lithium metal is selected from the group consisting of: a physical vapor deposition (PVD) system, a thin film transfer system, a lamination system, and a slot-die deposition system.

In one implementation, the first processing chamber 220 is an evaporation chamber. The evaporation chamber has a processing region 242 that is shown to comprise an evaporation source 244a, 244b (collectively 244) that may be placed in a crucible, which may be a thermal evaporator or an electron beam evaporator (cold) in a vacuum environment, for example.

The second processing chamber 230 is configured for forming an SEI film on the lithium metal film. The SEI film may be an ion-conducting material as described herein. The SEI film can be formed by PVD processes, such as sputtering, electron beam evaporation, thermal evaporation, a slot-die process, a transfer process, or a three-dimensional lithium printing process. The chamber for depositing the thin film of lithium metal may include a PVD system, such as an electron-beam evaporator, a thermal evaporation system, or a sputtering system, a thin film transfer system (including large area pattern printing systems such as gravure printing systems) or a slot-die deposition system. In one implementation, the chamber for depositing the solid electrolyte interphase film on the surface of the thin film of lithium metal is selected from the group consisting of: an electron-beam evaporator, a thermal evaporation system, or a sputtering system.

In one implementation, the second processing chamber 230 is an evaporation chamber. The second processing chamber 230 has a processing region 252 that is shown to comprise an evaporation source 254a, 254b (collectively 254) that may be placed in a crucible, which may be a thermal evaporator or an electron beam evaporator (cold) in a vacuum environment, for example.

In one implementation, the processing region 242 and the processing region 252 remain under vacuum and/or at a pressure below atmosphere during processing. The vacuum level of processing region 242 may be adjusted to match the vacuum level of the processing region 252. In one implementation, the processing region 242 and the processing region 252 remain at atmospheric pressure during processing. In one implementation, the processing region 242 and the processing region 252 remain under an inert gas atmosphere during processing. In one implementation, the inert gas atmosphere is an argon gas atmosphere. In one implementation, the inert gas atmosphere is a nitrogen gas (N₂) atmosphere.

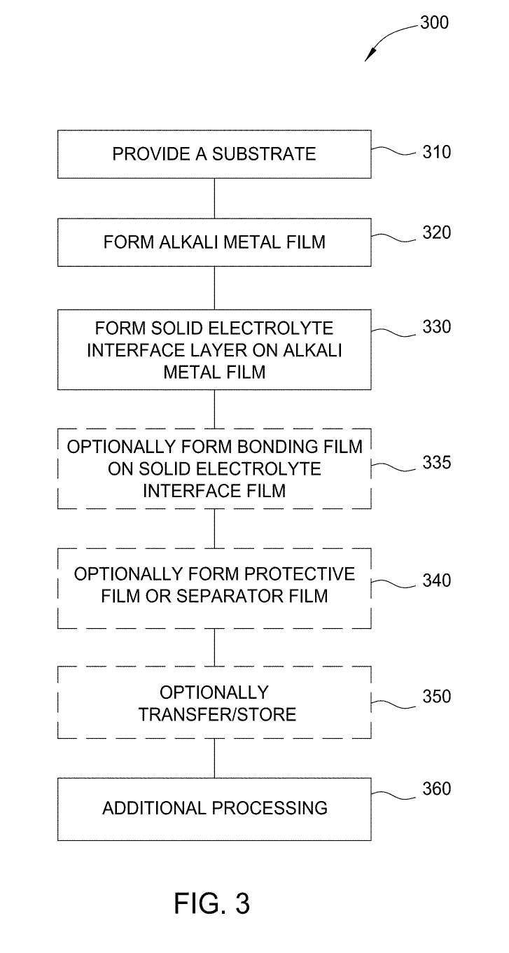

FIG. 3 illustrates a process flow chart summarizing one implementation of a method 300 for forming an electrode structure according to implementations described herein. At operation 310, a substrate is provided. In one implementation, the substrate is a continuous sheet of material 210. In one implementation, the substrate is the anode current collector 160. Examples of metals that the substrate may be comprised of include aluminum (Al), copper (Cu), zinc (Zn), nickel (Ni), cobalt (Co), tin (Sn), silicon (Si), manganese (Mn), magnesium (Mg), clad materials, alloys thereof, and combinations thereof. In one implementation, the substrate is copper material. In one implementation, the substrate is perforated. Furthermore, the substrate may be of any form factor (e.g., metallic foil, sheet, or plate), shape and micro/macro structure.

At operation 320, an alkali metal film is formed. In one implementation, the alkali metal film is a lithium metal film. In one implementation, the alkali metal film is a sodium metal film. In one implementation, the alkali metal film is formed on the substrate. The alkali metal film may be the anode film 150. In some implementations, if an anode film is already present on the substrate, the alkali metal film is formed on the anode film. If the anode film 150 is not present, the alkali metal film may be formed directly on the substrate. The alkali metal film may be formed in the first processing chamber 220. Any suitable alkali metal film deposition process for depositing thin films of alkali metal may be used to deposit the thin film of alkali metal. Deposition of the thin film of alkali metal may be by PVD processes, such as evaporation, a slot-die process, a transfer process, or a three-dimensional lithium printing process. The chamber for depositing the thin film of alkali metal may include a PVD system, such as an electron-beam evaporator, a thermal evaporator, or a sputtering system, a thin film transfer system (including large area pattern printing systems such as gravure printing systems) or a slot-die deposition system.

At operation 330, a solid electrolyte interphase is formed on the alkali metal film. The solid electrolyte interphase may be SEI film 140. The SEI film 140 may be a lithium fluoride film or a lithium carbonate film. The SEI film 140 may be formed in the second processing chamber 230. In one implementation, the SEI film 140 is formed via an evaporation process. The material to be deposited on the substrate is exposed to an evaporation process to evaporate the material to be deposited in a processing region. The evaporation material may be chosen from the group consisting of lithium (Li), lithium fluoride (LiF) (e.g., ultra-high pure single crystal lithium), lithium carbonate (Li₂CO₃), or combinations thereof. Typically, the material to be deposited includes a metal such as lithium. Further, the evaporation material may also be an inorganic compound. The evaporation material is the material that is evaporated during the evaporation process and with which the lithium metal film is coated. The material to be deposited (e.g., lithium fluoride) can be provided in a crucible. The lithium fluoride for example, can be evaporated by thermal evaporation techniques or by electron beam evaporation techniques.

In some implementations, the evaporation material is fed to crucible in pellet format. In some implementations, the evaporation material is fed to the crucible as a wire. In this case, the feeding rates and/or the wire diameters have to be chosen such that the sought after ratio of the evaporation material and the reactive gas is achieved. In some implementations, the diameter of the feeding wire for feeding to the crucible is chosen between 0.5 mm and 2.0 mm (e.g., between 1.0 mm and 1.5 mm). These dimensions may refer to several feedings wires made of the evaporation material. Typical feeding rates of the wire are in the range of between 50 cm/min and 150 cm/min (e.g., between 70 cm/min and 100 cm/min).

The crucible is heated in order to generate a vapor to coat the lithium metal film with the SEI film. Typically, the crucible is heated by applying a voltage to the electrodes of the crucible, which are positioned at opposite sides of the crucible. Generally, according to implementations described herein, the material of the crucible is conductive. Typically, the material used as crucible material is temperature resistant to the temperatures used for melting and evaporating. Typically, the crucible of the present disclosure is made of one or more materials selected from the group consisting of metallic boride, metallic nitride, metallic carbide, non-metallic boride, non-metallic nitride, non-metallic carbide, nitrides, titanium nitride, borides, graphite, tungsten, TiB₂, BN, B₄C, and SiC.

The material to be deposited is melted and evaporated by heating the evaporation crucible. Heating can be conducted by providing a power source (not shown) connected to the first electrical connection and the second electrical connection of the crucible. For instance, these electrical connections may be electrodes made of copper or an alloy thereof. Thus, heating is conducted by the current flowing through the body of the crucible. According to other implementations, heating may also be conducted by an irradiation heater of an evaporation apparatus or an inductive heating unit of an evaporation apparatus.

The evaporation unit according to the present disclosure is typically heatable to a temperature of between 800 degrees Celsius and 1200 degrees Celsius, such as 845 degrees Celsius. This is done by adjusting the current through the crucible accordingly, or by adjusting the irradiation accordingly. Typically, the crucible material is chosen such that its stability is not negatively affected by temperatures of that range. Typically, the speed of the porous polymeric substrate is in the range of between 20 cm/min and 200 cm/min, more typically between 80 cm/min and 120 cm/min such as 100 cm/min. In these cases, the means for transporting should be capable of transporting the substrate at those speeds.

At operation 335, optionally, a bonding film is formed on the SEI film. The bonding film may be bonding film 195. The bonding film 195 may be a lithium fluoride film or a lithium carbonate film. The bonding film may be formed in an additional processing chamber (not shown). In one implementation, the bonding film comprises a gel polymer (e.g., organic-inorganic composites), a solid polymer, carbon-containing materials (e.g., graphite), or combinations thereof. The polymer can be chosen from polymers currently used in the Li-ion battery industry. Examples of polymers that may be used to form the bonding film 195 include, but are not limited to, polyvinylidene difluoride (PVDF), polyethylene oxide (PEO), poly-acrylonitrile (PAN), carboxymethyl cellulose (CMC), styrene butadiene rubber (SBR), and combinations thereof. The bonding film can be formed by dip-coating, slot-die coating, gravure coating, chemical vapor deposition (CVD) processes, physical vapor deposition (PVD) processes, and/or printing. The polymer can also be deposited using Applied Materials Metacoat equipment. The bonding film may have a thickness from about 0.01 micrometers to about 1 micrometers (e.g., from about 0.01 micrometers to about 0.5 micrometers; from about 0.1 micrometers to about 2 micrometers; or from about 0.5 micrometers to about 5 micrometers).

In one implementation, the bonding film 195 comprises a gel polymer (e.g., organic-inorganic composites), a solid polymer, carbon-containing materials (e.g., graphite), or combinations thereof. The polymer can be chosen from polymers currently used in the Li-ion battery industry. Examples of polymers that may be used to form the bonding film 195 include, but are not limited to, polyvinylidene difluoride (PVDF), polyethylene oxide (PEO), poly-acrylonitrile (PAN), carboxymethyl cellulose (CMC), styrene butadiene rubber (SBR), and combinations thereof. Not to be bound by theory but it is believed that the bonding film 195 can up-take Li-conducting electrolyte to form gel during device fabrication which is beneficial for forming good solid electrolyte interface (SEI) and also helps lower resistance. The bonding film 195 can be formed by dip-coating, slot-die coating, gravure coating, chemical vapor deposition (CVD) processes, physical vapor deposition (PVD) processes, and/or printing. The polymer can also be deposited using Applied Materials Metacoat equipment. The dielectric polymer layer may have a thickness from about 0.01 micrometers to about 1 micrometers (e.g., from about 0.01 micrometers to about 0.5 micrometers; from about 0.1 micrometers to about 2 micrometers; or from about 0.5 micrometers to about 5 micrometers).

At operation 340, optionally, a protective film or separator film is formed. In one implementation, the protective film or separator film may be formed directly on the SEI film. In another implementation, the protective film or separator film may be formed directly on the bonding film if present. The separator film may be separator film 130. The protective film may be protective film 180. The protective film 180 or separator film may be an ion-conducting polymer. The protective film or separator film may be formed in a third processing chamber (not shown). At operation 350, the substrate with the lithium metal film, the SEI film and the protective film may optionally be stored, transferred to another tool, or both stored and transferred. At operation 350, the substrate with the lithium metal film and the protective film formed thereon is subject to additional processing.

At operation 350, the substrate with the lithium metal film and the protective film may optionally be stored, transferred to another tool, or both. At operation 360, the substrate with the lithium metal film and the protective film formed thereon is optionally subjected to additional processing.

### Examples

The following non-limiting examples are provided to further illustrate implementations described herein. However, the examples are not intended to be all-inclusive and are not intended to limit the scope of the implementations described herein.

The examples described herein were performed on an AMOD PVD Platform currently available from Angstrom Engineering. The LiF films were grown in this work by thermal evaporation in vacuum by heating the source to ˜845 degrees Celsius. The LiF films were deposited on a substrate. The substrate used was lithium metal. The lithium metal was purchased from FMC Corporation. In some examples for comparison purposes, a silicon substrate was used. The vapor pressure in the processing region of the chamber was maintained at less than 10-15 mbar. The LiF source material was preheated in a vacuum environment to eliminate moisture. Prior to positioning in the processing region, the lithium metal substrate was cleaned using a stainless steel brush to remove oxide and other surface impurities. The LiF source material and the lithium substrate were maintained at a distance of 10 centimeters. The evaporation rate was kept at 20 Å/seconds and the film thickness was kept of the order of 1 to 50 nm. The substrate temperature varied from ˜40 degrees Celsius to 120 degrees Celsius.

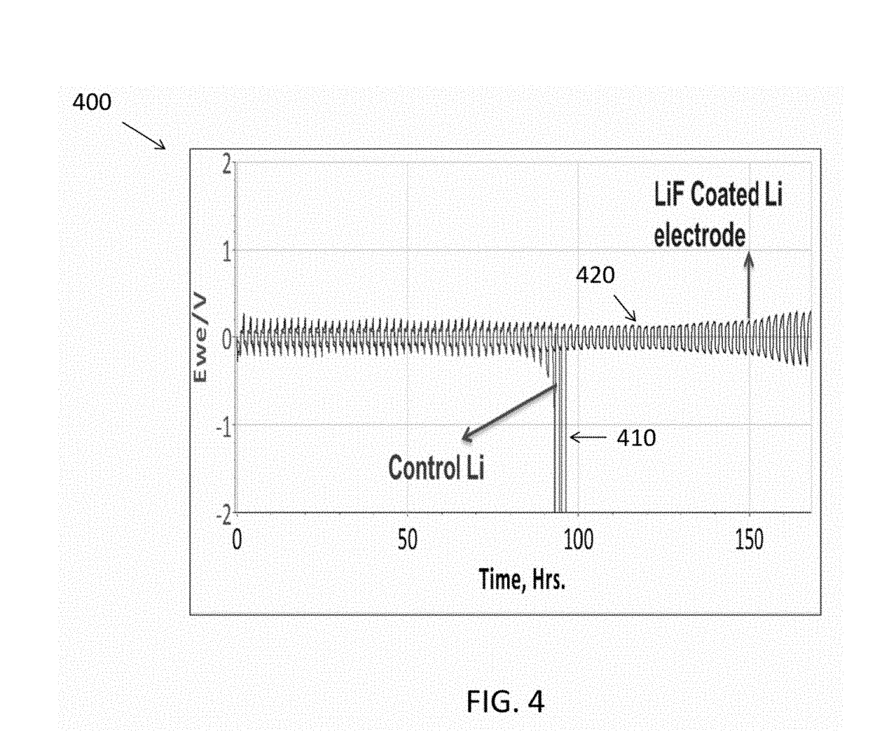

FIG. 4 illustrates a plot 400 of cell voltage versus time (hours) for a symmetric lithium cell at a current density of 3.0 mA cm⁻². Trace 410 corresponds to a control electrode of Li metal on copper foil with no SEI film versus trace 420, which corresponds to an electrode of Li metal on copper foil with 12 nm of LiF coating on the Li metal. The galvanostatic cycling measurements in plot 400 demonstrate that the presence of the 12 nanometer SEI film of LiF on lithium metal in 1M LiPF₆ (EC:DEC 2% FEC) provides more than double the enhancement in cell lifetime over the control lithium metal with no LiF.

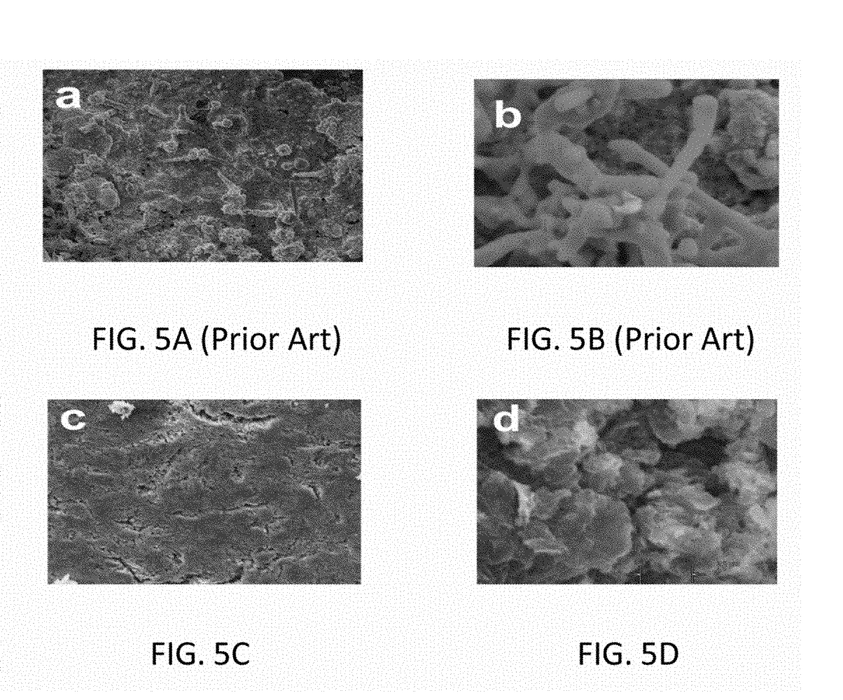

FIGS. 5A-5B illustrate scanning electron microscopy (SEM) images of an untreated lithium metal electrode formed according to implementations described herein. FIGS. 5C-5D illustrate SEM images of a treated lithium metal electrode formed thereon according to implementations described herein. The morphologies of the lithium metal electrode surface from galvanostatic cycling measurements were analyzed by scanning electron microscopy. FIGS. 5A-5B show the lithium surface after cycling for 80 hours in 1M LiPF₆ (EC: DEC 2% FEC). The lithium electrode contact with the control Li metal forms needle-like nanostructures, while the lithium surface in contact with the LiF-containing electrolyte forms a high surface area lithium electrodeposit as shown in FIGS. 5C-5D. These results demonstrate that the voltage instabilities observed in FIG. 4 and the improved stability directly results from the interphase modifications of LiF.

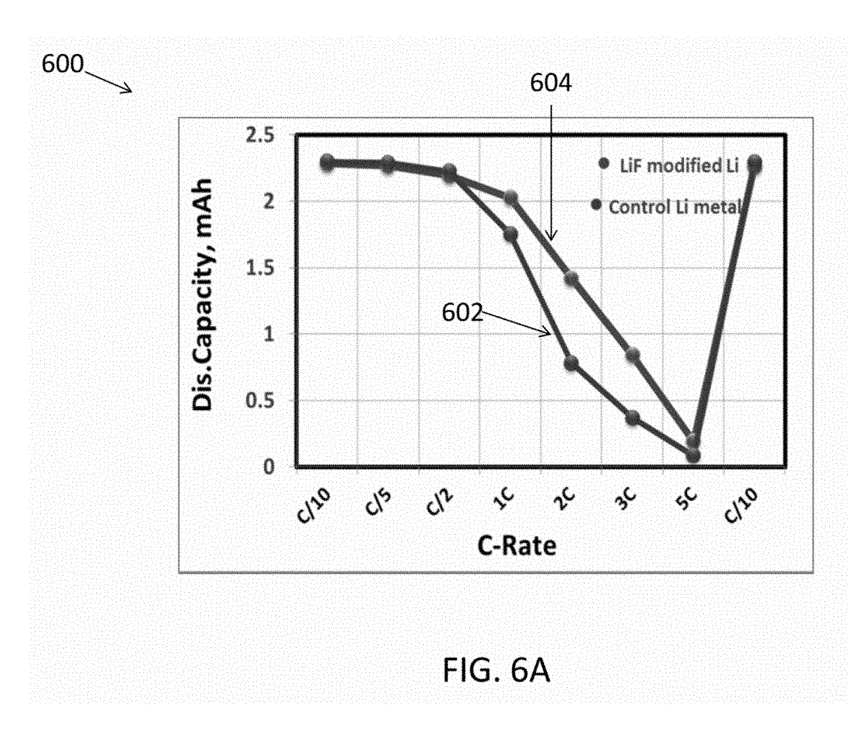

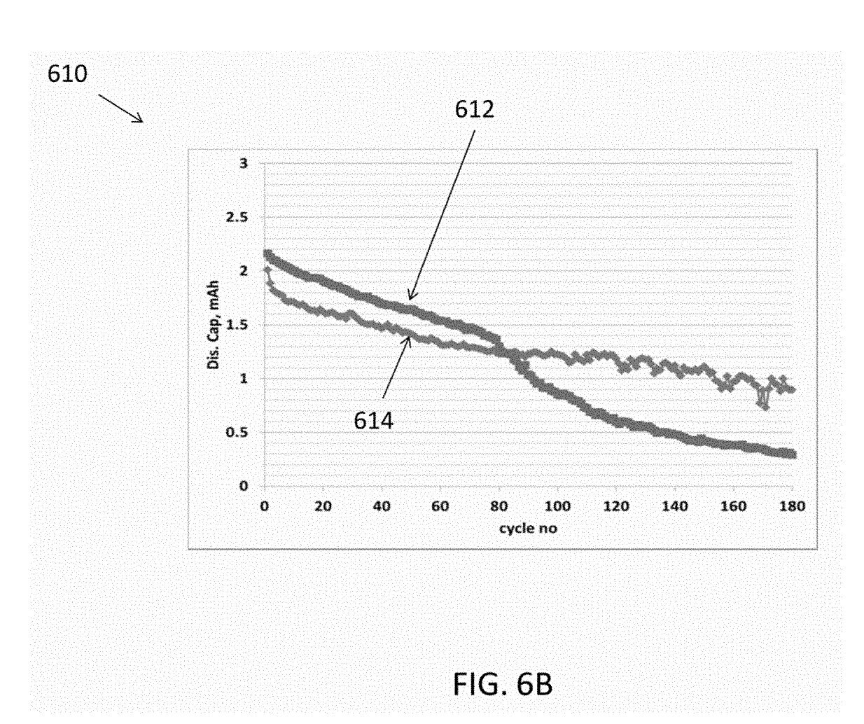

FIG. 6A illustrates a plot 600 of discharge capacity versus C-rate performance for a lithium metal electrode without the SEI film verses a lithium metal electrode having an SEI film formed according to implementations described herein. Trace 602 represents the unmodified control lithium electrode and trace 604 represents a lithium metal electrode having a LiF film formed according to implementations described herein. FIG. 6B illustrates a plot 610 of discharge capacity versus cycle number for a lithium metal electrode without the SEI film verses a lithium metal electrode having an SEI film formed according to implementations described herein. Trace 612 represents the unmodified control lithium electrode and trace 614 represents a lithium electrode having a LiF film formed according to implementations described herein. Full cells were made with Li metal as anode and commercial Lithium Cobalt oxide as cathode with 1M LiPF₆ (EC: DEC 2% FEC) electrolytes. It is observed from the galvanostatic polarization measurements at different C-rates depicted in FIG. 6B, a LiF containing Li metal interphase shows a maximum improvement in C-rate performance. It is further observed from FIG. 6B that cells containing 12 nm LiF on a lithium metal electrode are able to cycle for at least 180 cycles at high current density (3 mA/cm²).

Although implementations of the present disclosure have been particularly described with reference to lithium-ion batteries with graphitic negative electrodes, the teaching and principles of the present disclosure may be applicable to other alkali-based batteries such as Li-polymer, Li—S, Li—FeS₂, Li metal based batteries, etc. For the Li metal-based batteries such as Li—S and Li—FeS₂ a thicker Li metal electrode may be needed and the thickness of Li metal depends on the positive electrode loading. In some implementations the Li metal electrode may be between 3 and 30 microns thick for Li—S and roughly 190-200 microns for Li—FeS₂, and may be deposited on one or both sides of a compatible substrate such as a Cu or stainless steel metal foil—the methods and tools described herein may be used to fabricate such Li metal electrodes.

In summary, some of the benefits of the present disclosure include the efficient integration of SEI film deposition into currently available processing systems. Currently, SEI films are formed in-situ during initial charging of the battery. These in-situ films suffer from the randomness of metallic lithium embedded in the anode during intercalation results in dendrite formation. It has been found by the inventors that coating the lithium metal with an SEI film prior to initial charge of the energy storage device, provides a reduction in dendrite formation formed from anode materials. This reduction in dendrite formation leads to, among other things, improved cycling and C-Rate.

When introducing elements of the present disclosure or exemplary aspects or implementation(s) thereof, the articles “a,” “an,” “the” and “said” are intended to mean that there are one or more of the elements.

The terms “comprising,” “including” and “having” are intended to be inclusive and mean that there may be additional elements other than the listed elements.

While the foregoing is directed to implementations of the present disclosure, other and further implementations of the disclosure may be devised without departing from the basic scope thereof, and the scope thereof is determined by the claims that follow.

1. An energy storage device, comprising:
a cathode film including a lithium transition metal oxide;
a separator film coupled to the cathode film and capable of conducting ions;
a solid electrolyte interphase film coupled to the separator, wherein the solid electrolyte interphase film is a lithium fluoride film or a lithium carbonate film;
a lithium metal film coupled to the solid electrolyte interphase film; and
an anode current collector coupled to the lithium metal film.

2. The energy storage device of claim 1, wherein the solid electrolyte interphase film has a thickness between about 10 nanometers and about 20 nanometers.

3. The energy storage device of claim 1, further comprising a cathode current collector coupled to the cathode film.

4. The energy storage device of claim 1, wherein the solid electrolyte interphase film is deposited by a physical vapor deposition process.

5. The energy storage device of claim 1, wherein the solid electrolyte interphase film is deposited on the lithium metal film prior to an initial charge.

6. The energy storage device of claim 1, wherein the solid electrolyte interphase film is a lithium fluoride film.

7. The energy storage device of claim 1, further comprising a bonding film positioned between the separator film and the solid electrolyte interphase film.

8. The energy storage device of claim 7, wherein the bonding film comprises a gel polymer, a solid polymer, carbon-containing materials, or combinations thereof.

9. The energy storage device of claim 8, wherein the bonding film is formed by dip-coating, slot-die coating, gravure coating, chemical vapor deposition (CVD) processes, physical vapor deposition (PVD) processes, and/or printing.

10. A method of forming an energy storage device, comprising:
depositing a solid electrolyte interphase layer on a lithium film by a physical vapor deposition (PVD) process, a slot-die process, a thin-film transfer process, or a three-dimensional lithium printing process, wherein the solid electrolyte interphase layer is a lithium fluoride film or a lithium carbonate film.

11. The method of claim 10, wherein the solid electrolyte interphase film is deposited by a physical vapor deposition process.

12. The method of claim 10, wherein the solid electrolyte interphase film is deposited on the lithium metal film prior to an initial charge.

13. The method of claim 10, further comprising depositing a protective film on the solid electrolyte interphase layer, wherein the protective film is an interleaf film or an ion-conducting polymer film.

14. The method of claim 10, further comprising depositing a bonding film on the solid electrolyte interphase layer, wherein the bonding film comprises a gel polymer, a solid polymer, carbon-containing materials, or combinations thereof.

15. The method of claim 14, wherein the bonding film is deposited by dip-coating, slot-die coating, gravure coating, chemical vapor deposition (CVD) processes, physical vapor deposition (PVD) processes, and/or printing.

16. The method of claim 14, further comprising depositing a separator film on the bonding film.

17. An integrated processing tool for forming lithium coated electrodes, comprising:
a reel-to-reel system for transporting a continuous sheet of material through following processing chambers:
a chamber for depositing a thin film of lithium metal on the continuous sheet of material; and
a chamber for depositing a solid electrolyte interphase film on a surface of the thin film of lithium metal, wherein the solid electrolyte interphase layer is a lithium fluoride film or a lithium carbonate film.

18. The integrated processing tool of claim 17, wherein the chamber for depositing the thin film of lithium metal is selected from the group consisting of: a physical vapor deposition (PVD) system, a thin film transfer system, a lamination system, and a slot-die deposition system.

19. The integrated processing tool of claim 18, wherein the chamber for depositing the solid electrolyte interphase film on the surface of the thin film of lithium metal is selected from the group consisting of: an electron-beam evaporator, a thermal evaporation system, or a sputtering system.

20. The integrated processing tool of claim 18, wherein the continuous sheet of material is a flexible conductive substrate.
